(19) United States
(12) Patent Application Publication
(10) Pub. No.: US 2005/0173527 A1
(43) Pub. Date: Aug. 11, 2005

(54) Product checkout system with anti-theft device

(75) Inventor: Vincent Charles Conzola, Raleigh, NC (US)

Correspondence Address: KELLY K. KORDZIK;WINSTEAD SECHREST & MINICK PC, PO BOX 50784, DALLAS, TX, 75201, US

(73) Assignee: International Business Machines Corporation, Armonk, NY (US)

(21) Appl. No.: 10/776,112

(22) Filed: Feb. 11, 2004

(51) Int. Cl. G06K 15/00; G06F 17/60

(52) U.S. Cl. 235/385; 235/383

(57) ABSTRACT

A checkout system for processing a product with an electronic article surveillance tag attached thereto, including the following: computer, database for storing physical features for said product, register means, means for establishing one or more physical characteristics for said product, means for comparing said characteristics to said features, and means for deactivating said tag with a deactivation device.

### TECHNICAL FIELD

The present invention is directed to an improved system and method for product checkout systems that incorporate anti-theft technology.

### BACKGROUND INFORMATION

A traditional retail or grocery store checkout lane typically includes a cash register that is used to check out merchandise items bearing bar code labels. A cashier removes items from a movable conveyor belt one at a time, drags them across the laser beam of a fixed scanner (e.g., a “slot” scanner built into a horizontal counter), and places them on a shopping carrier, such as a cart. The fixed scanner is linked with a processor, e.g., a CPU built into the cash register, that translates the bar code symbol on a package into a cash register entry including the price of the scanned item. Downstream of the cash register there may be a sacking station whereby one or more baggers remove previously scanned items from the conveyor belt and places items in paper or plastic sacks. When all items have been scanned or otherwise checked, the cash register tallies the prices of the items, factors in any discounts (e.g., coupon discounts) or other adjustments (e.g., sales taxes on some items), displays the total to be paid by the customer, and prints a receipt. While the purchases are being “rung up,” the customer may write a check to pay for the purchases or deliver a credit card to the cashier.

A twist on the aforementioned checkout method is the use of automated self-checkout systems, such as the U-Scan Express® line of systems available from Optimal Robotics Corp., that enable customers to scan, bag and pay for their purchases themselves, with limited need for interaction by store personnel. Self-checkout systems have been adopted by supermarket and discount retailers looking to speed up service and cut back on labor costs.

With both traditional and self-checkout systems, shoplifting is a major problem that results in the loss of millions of dollars each year. The most common type of shoplifting is that in which the shoplifter removes the shoplifted item from a store by wearing the item or by hiding the item on their person or in their bags. One well-known system developed to reduce this type of shoplifting involves attaching a security tag to the items in the store. The security tag contains a circuit (e.g., RFID tag) or other means that interacts with a detection system located near the exit of the store. The detection system sounds an alarm if an item passes therethrough with a security tag that has not been deactivated. This type of security tag is typically removed or deactivated by a cashier or customer when the item is purchased by passing the tag over an electromagnetic apparatus.

However, with the traditional check-out system, a problem arises with this type of security system in that if a store cashier is acting in concert with the shoplifter, the cashier may deactivate or remove the security tags without accepting payment for the items. Typically, the shoplifter will bring a number of purchases to the cashier, who will ring up less than all of the purchases, often discounting the prices on the purchased items. The cashier will then place the remaining unpurchased items in the shoplifter's bags. Prior to placing the items in the bags, the cashier will deactivate the security tags on the stolen items so that the security detection apparatus near the exit of the store will not detect them. Therefore, if a cashier is acting in concert with a shoplifter, it is possible to steal a very large number of items with relative ease. These problems also exist with a self-checkout system because the customer can deactivate the security tag without having paid for the item.

In view of the above, it should be apparent that a method which allows merchandise checkouts to have a high level of security in processing purchased merchandise items would be highly desirable.

### SUMMARY OF INVENTION

It is therefore one object of the present invention to provide an improved system and method for product checkout systems that incorporate anti-theft technology. This object is achieved as follows.

An embodiment of the invention utilizes: a product with a security tag and bar code that indicates product price and product physical characteristics such as weight, size and shape. Also included is a database for storage of such information, a bar code scanner, a computer, a network interface, a network, a display for showing the product price, a speaker for presenting information to consumers and employees, a deactivation device for deactivating the security tags and a physical characteristic evaluator.

After a product is scanned, the computer recalls the physical characteristics associated with the bar code on the scanned product. Then, the physical features of the scanned product are ascertained with a physical characteristic evaluator. This evaluator may be a scale that weighs the product. In another embodiment, the evaluator may be a back-lit illumination device, coupled with pattern recognition software, that determines product shape. The evaluator may evaluate more than one such characteristic. After evaluation, the computer compares the physical characteristics associated with the bar code on the scanned product to the physical features of the scanned product that were ascertained with a physical characteristic evaluator. If the values match within a specified threshold, the deactivation device is enabled and deactivates the security tag. If no such match is made, security personnel are alerted.

The above, as well as additional objects, features, and advantages of the present invention, will become apparent in the following detailed written description.

### BRIEF DESCRIPTION OF THE DRAWINGS

A better understanding of the present invention can be obtained when the following detailed description is considered in conjunction with the following drawings, in which:

FIG. 1 is a block diagram of a prior art checkout system;

FIG. 2 is a flow chart of a prior art checkout system;

FIG. 3 is a block diagram of a checkout system using security tags and physical characteristic evaluator;

FIG. 4 is a flow chart of a checkout system using security tags and physical characteristic evaluator;

FIG. 5 is a circuit diagram of a security tag;

FIG. 6 is a flow chart of a checkout system using security tags, physical characteristic evaluator and substantially enclosed space; and

FIG. 7 is a checkout system incorporating use of a substantially enclosed space.

### DETAILED DESCRIPTION

In the following description, numerous specific details are set forth to provide a thorough understanding of the present invention. However, it will be obvious to those skilled in the art that the present invention may be practiced without such specific details. For the most part, details concerning specific non-essential materials and the like have been omitted inasmuch as such details are not necessary to obtain a complete understanding of the present invention and are within the skills of persons of ordinary skill in the relevant art.

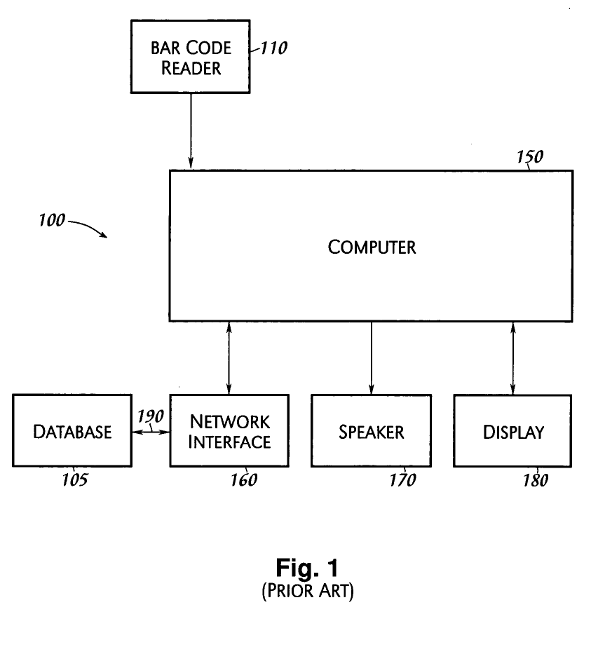

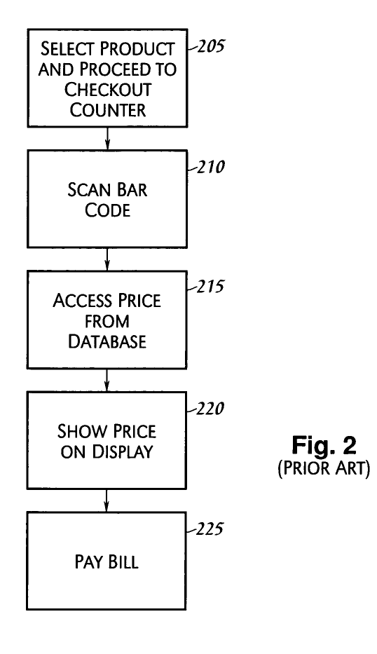

Many products in the store have a UPC (or similar) bar code associated with their packaging. Concerning the prior art in FIGS. 1 and 2, the bar code is tied to a price for the product in a database 105. The consumer selects a product and proceeds to a checkout counter 205. There, the bar code is scanned 210 with a bar code reader 110 and the corresponding price for that SKU number is retrieved from the database 215 using a computer 150, network interface 160 and network 190. The price is added to the total bill for that consumer. The product price is visible 220 on a display 180 and may be announced using a speaker 170. The total bill may also be visible on the display 180. The consumer pays 225 the total bill.

Bar code reader 110 may be any bar code reader, including an optical bar code scanner which uses laser beams to read bar codes. Bar code reader 110 may be located within a checkout counter, mounted on top of a checkout counter or incorporated within a hand-held device.

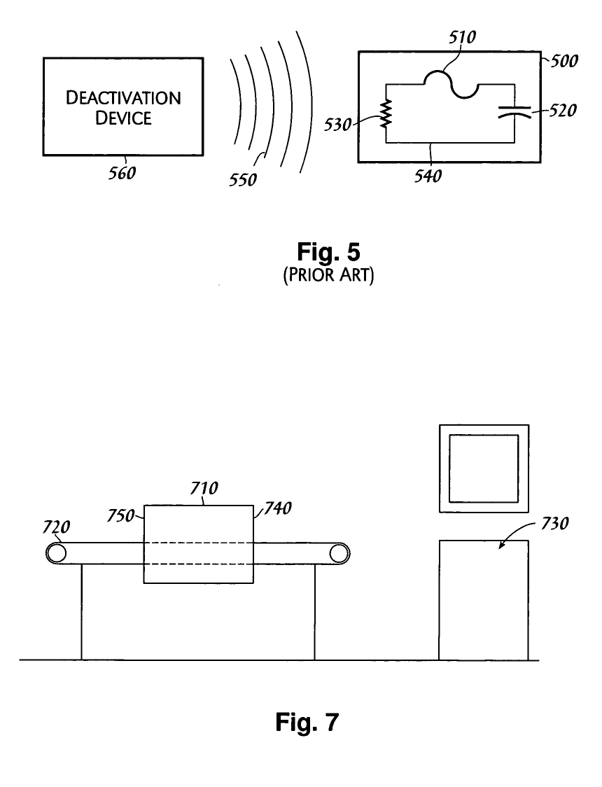

As shown in FIG. 5, the prior art deters theft by combining systems 100 and 200 with placing a security tag 500 on the product packaging in addition to the bar code. The security tag 500 consists of a resonating circuit 540 having a resistor 530, capacitor 520 and fuse 510 connected together in electrical series. In operation, the circuit 540 is designed to resonate at a particular electromagnetic frequency, for example in the 1 to 1.2 Ghz range. If a strong enough electromagnetic wave 550 impinges on the circuit, the circuit will excite and generate enough current to blow the fuse 510 thereby disabling the electrical circuit 540 and deactivating the security tag device 500. The electromagnetic wave 550 is emitted by a deactivation device 560 that incorporates RF circuitry to produce a frequency and generate sufficient power to emit the electromagnetic wave 550 through an antenna. It should be appreciated by those skilled in the art that the electrical circuit 540 might be fabricated using discrete components, mylar techniques or other thin film applications known in the electrical arts. If the security tag 500 is not deactivated, it will interact with security sensors, located at the store exit, and thereby alert store personnel who may then investigate the situation. The aforementioned prior art is well known and will not be further described here.

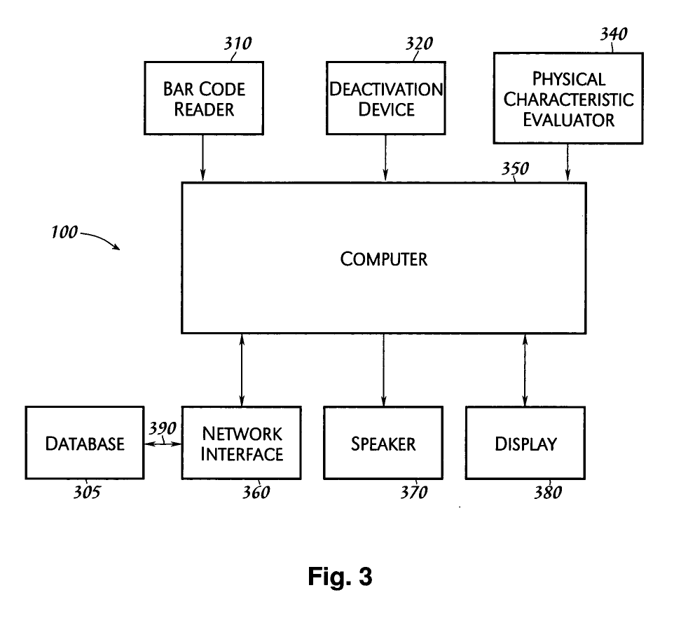

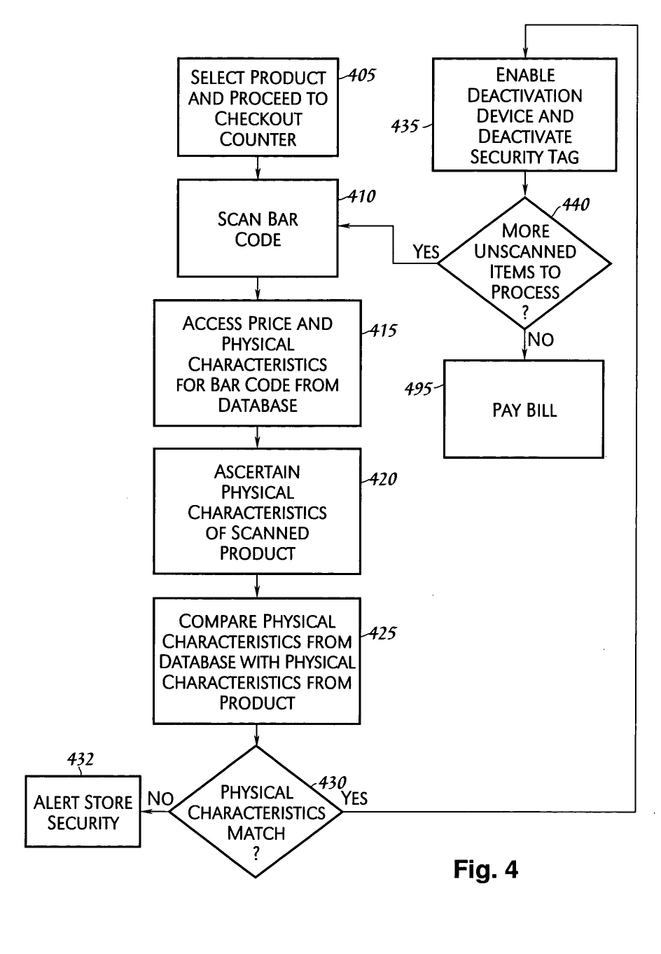

As shown in FIGS. 3 and 4, the present invention 400 adds a security measure by placing constraints on when the deactivation device 320 is enabled. Physical characteristics, in addition to price, are tied to the bar code in database 305. For example, product weight is tied to the product bar code in the database 305. Then, after a product is scanned 410 with a bar code reader 310, the computer 350 accesses the database 305 through network connection 360 and network 390 to retrieve the weight for the product 415. Next, the product is then placed on a scale 340 and weighed 420. The scale is incorporated in the physical characteristic evaluator 340. The computer 350 then compares the weight 425 from the scale 340 with the weight stored in the database 305 for that identified product. If the two weight values match 430 within a specified threshold, the deactivation device 320 is enabled and deactivates 435 security tag 500. Enablement of deactivation device 320 is only for a short time in order to deter a consumer or employee from attempting to deactivate other security tags on items that have not been scanned. If the two weight parameters do not match, store security can be automatically alerted 432 (e.g., phone call, alarm, light, etc.).

In addition, deactivation 435 can occur at random periods of time. Consequently, the shoplifter will have difficulty when trying to time the placement of an unscanned device in the electromagnetic field 550. The deactivation 435 can be tied to varying intervals of time after, for example, an item has been placed in a bag or after an item has been scanned 410. Detection of when an item has been placed in a bag can be accomplished using, for example, a scale 340 or motion detector.

Alternative embodiments of invention 400 may focus on physical characteristics other than weight. For example, size or shape of the product can be obtained 420 by placing the product in a physical characteristic evaluator 340 that incorporates a viewplate that, when coupled with an illumination source and video imaging equipment, produces backlit images. These images are then processed using pattern recognition techniques that are standard in the art to determine size and shape. Such techniques for size and shape recognition are well known to the skilled reader and will not be further described here. However, U.S. Pat. No. 6,592,033, as well as the prior art it cites, provides further insight. Said patent is incorporated by reference. Such evaluation occurs after the product has been scanned 410 and the stored size or shape for the product has been gathered from the database 415. The two physical characteristics can then be compared 425.

Other types of physical characteristics that can be evaluated include, but are not limited to, color, volume, surface area, surface texture, magnetic properties, acoustic characteristics and spectral fingerprint. Techniques for conducting such evaluations are well known and will not be further described here. However, in addition to the aforementioned U.S. Pat. No. 6,592,033, U.S. Pat. No. 6,530,521, as well as the prior art it cites, provides further insight if required. Said patents are incorporated by reference.

In addition, two or more physical characters (e.g., weight and shape) may be used in physical characteristic evaluation steps 415, 420, 425 and 430. Doing so frustrates shoplifters because any object being evaluated must mimic an increased number of characteristics associated with the product tied to the scanned bar code. Furthermore, using multiple physical characteristics increases the chance of properly ascertaining the physical characteristics for a product 420.

In addition, the aforementioned pattern recognition techniques may be used to identify the product and thus obviate the need for use of a scanner 410. In other words, once the pattern recognition techniques identify the product, the appropriate physical characteristics and price can then be accessed from the database 415. In addition, the aforementioned pattern recognition techniques also allow for more than one product to be identified 410 and evaluated 420 at a time using object segmentation techniques. Such techniques are well known to those skilled in the art and will not be further described here. However, U.S. Pat. No. 6,592,033, as well as the prior art it cites, provides further insight. Said patent is incorporated by reference.

In yet another embodiment of the invention, the above process involving evaluation of physical characteristics 415, 420, 425, 430 and 435 should be avoided if the store has declined to place a security tag on the product. Thus, when the price is tied to a bar code in database 305, the store may also link to that bar code whether a security tag is on the product. Upon scanning the product 410 and retrieving price and physical characteristics for the bar code from database 415, computer 350 will also determine whether the product has a security tag. If no security tag is identified in the database, computer 350 will prompt the consumer or employee, using a speaker 370 or display 380, to bypass the physical characteristic evaluator 340 and proceed directly to payment. In another embodiment, the product may proceed through the physical characteristic evaluator 340 but skip one or more of steps 420, 425, 430 and 435.

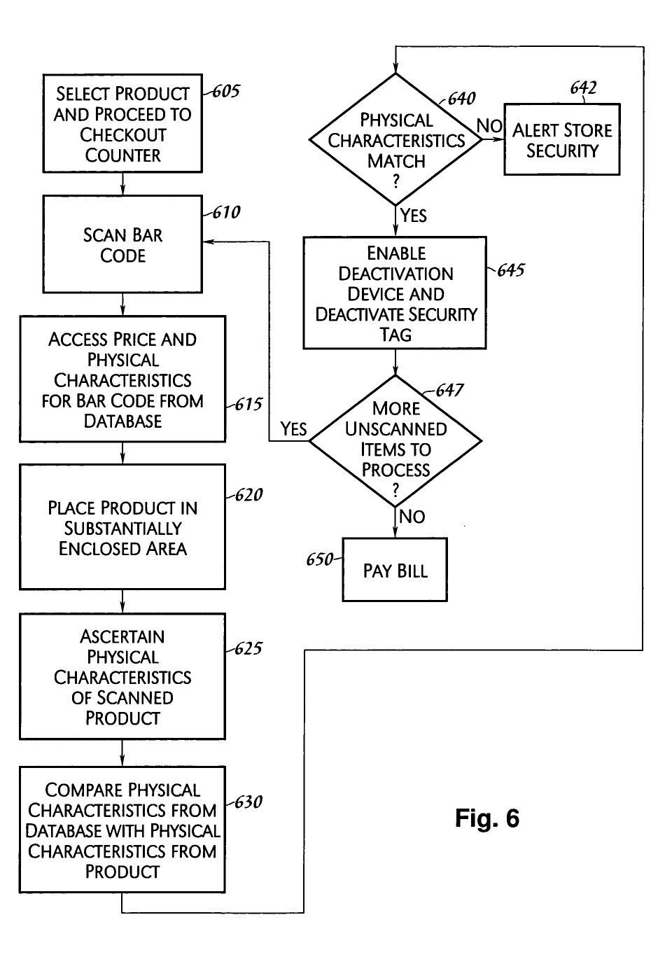

Still another embodiment of the invention is presented in FIG. 6 wherein a substantially enclosed area is used. For example, after scanning the product 610 and accessing the database 305 for physical characteristics 615, the product is placed in a substantially closed compartment 620. While in the compartment, the product's physical characteristics are examined 625 and compared to those located in the database 630. After a match between the characteristics is found by the computer 640, the deactivation device can be enabled 645. If no match is found, store security can be alerted 642. Use of a substantially enclosed area during evaluation 625 and deactivation 645 limits the possibility of placing an unscanned item in the path of the electromagnetic wave 550 during deactivation of a security tag 500. Furthermore, in an alternative embodiment, a circuit is constructed so that the deactivation device is not activated if the compartment is opened or violated after the physical characteristics have been gathered 625 but before deactivation has occurred 645.

The substantially enclosed area may be a box with a lid, that pivots around a hinge, located adjacent to the bar code reader 310. Or, as seen in FIG. 7, the substantially enclosed area may be within a cylinder 710, with a rectangular cross-section, that allows a conveyer belt 720 to pass through it. Consequently, after the product is scanned 610 by the scanner 730, the product is placed on the conveyor belt 720, advanced to within the tunnel 710, analyzed for physical characteristics 625 and has its security tag deactivated 625. Provided the tunnel 710 is long enough, no door is required at the entry 740 or exit 750 from the tunnel 710 because any person trying to place an unscanned product in the path of the electromagnetic field 550 during deactivation 645 would draw undue attention to himself.

In another embodiment, the field 550 emitted by the deactivation device 320 is substantially limited to the substantially enclosed area. Such limitation is commonplace in the industry by proper selection of materials for the substantially enclosed area and/or by constraining the field's 550 strength or direction. Such techniques for constraining the field 550 are well known to the skilled reader and will not be further described here.

Although the present invention and its advantages have been described in detail, it should be understood that various changes, substitutions and alterations can be made herein without departing from the spirit and scope of the invention.

1-8. (canceled)

9. A check-out method for a product having a security tag associated therewith, comprising the steps of:
storing one or more physical characteristics for said product;
recalling said one or more physical characteristics when a consumer checks out said product;
placing said product in a substantially enclosed area;
examining said product while said product is in said substantially enclosed area;
establishing one or more physical features for said product while said product is in said substantially enclosed area;
comparing said one or more physical characteristics to said one or more physical features;
generating a signal if said one or more physical characteristics substantially match said one or more physical features; and
deactivating said tag with a deactivation device after receipt of said signal and while said product is in said substantially enclosed area.

10. The method according to claim 9 wherein said one or more physical characteristics and said one or more physical features pertain to weight.

11. The method according to claim 9 wherein said one or more physical characteristics and said one or more physical features pertain to size.

12. The method according to claim 9 wherein said one or more physical characteristics and said one or more physical features pertain to shape.

13. The method according to claim 9 wherein said one or more physical characteristics and said one or more physical features pertain to color.

14. The method according to claim 9 wherein said one or more physical characteristics and said one or more physical features pertain to two or more of the following: weight, size, shape, color or surface texture.

15. The method according to claim 9 further comprising the step of ensuring no other object is in said substantially enclosed area once said product has been placed in said substantially enclosed area but before said tag has been deactivated.

16. The method according to claim 15 further comprising the step of generating an alert signal if an object, in addition to said product, is detected to be in said substantially enclosed area once said product has been placed in said substantially enclosed area but before said tag has been deactivated.

17. The method according to claim 16 further comprising the step of preventing any deactivation of said tag once said alert signal has been generated.

18-23. (canceled)

24. A check-out system for a product having a security tag associated therewith, comprising:
a substantially enclosed area;
a database for storing one or more physical characteristics for said product;
a scanner for retrieving from said database said one or more physical characteristics;
a physical characteristic evaluator for establishing one or more physical features for said product while said product is in said substantially enclosed area;
a computer for comparing said one or more physical characteristics to said one or more physical features;
an electronic circuit for generating a signal if said one or more physical characteristics substantially match said one or more physical features; and
a deactivation device for deactivating said tag after receipt of said signal and while said product is in said substantially enclosed area.

25. The system according to claim 24 wherein said one or more physical characteristics and said one or more physical features pertain to weight.

26. The system according to claim 24 wherein said one or more physical characteristics and said one or more physical features pertain to size.

27. The system according to claim 24 wherein said one or more physical characteristics and said one or more physical features pertain to shape.

28. The system according to claim 24 wherein said one or more physical characteristics and said one or more physical features pertain to color.

29. The system according to claim 24 wherein said one or more physical characteristics and said one or more physical features pertain to two or more of the following: weight, size, shape, color or surface texture.

30. The system according to claim 24 further comprising a means for ensuring no other object is in said substantially enclosed area once said product has been placed in said substantially enclosed area but before said tag has been deactivated.

31. The system according to claim 30 further comprising means for generating an alert signal if an object, in addition to said product, is detected to be in said substantially enclosed area once said product has been placed in said substantially enclosed area but before said tag has been deactivated.

32. The system according to claim 31 further comprising means for preventing any deactivation of said tag once said alert signal has been generated.
